(19) United States
(12) Patent Application Publication
(10) Pub. No.: US 2021/0049638 A1
(43) Pub. Date: Feb. 18, 2021

(54) CREDIT CARD REWARD OPTIMIZER

(71) Applicant: Arash Behravesh, Arlington, VA (US)

(72) Inventor: Arash Behravesh, Arlington, VA (US)

(21) Appl. No.: 16/990,228

(22) Filed: Aug. 11, 2020

Related U.S. Application Data
(60) Provisional application No. 62/885,543, filed on Aug. 12, 2019.

(51) Int. Cl. G06Q 30/02; G06Q 20/20; G06Q 10/10; G06Q 20/40; G06Q 40/02; G06Q 20/34; G06F 16/2455; G06F 16/2457; G06N 5/04

(52) U.S. Cl. CPC G06Q 30/0238; G06Q 20/209; G06Q 10/10; G06Q 30/0235; G06Q 20/405; G06Q 30/0215; G06N 5/04; G06Q 30/0213; G06Q 40/02; G06Q 20/34; G06F 16/24553; G06F 16/24578; G06Q 30/0226

(57) ABSTRACT

A computing device including a location determinator including a position detector, a merchant information detector, and a category or subcategory detector. The computing device also includes one or more processors and one or more non-transitory computer-readable storage media embodying computer-readable instructions, which can determine at least one of category or sub-category of a potential transaction based on information derived from the location determinator, retrieve account information of a plurality of payment applications, retrieve reward rules associated with each of the plurality of payment applications, determine available rewards based on each of the retrieved reward rules, based on the determine available rewards, rank each of the plurality of payment applications, and communicate information of a highest ranked payment application to a point of sale terminal.

### FIELD

This disclosure relates to a credit card transaction system and particularly to a system that recommends which credit card to use to optimize the rewards associated with each credit card.

### BACKGROUND

The use of credit cards, debit cards, and other payment applications is pervasive in the modern marketplace. A typical consumer has multiple credit cards, each with different reward programs regarding their use (e.g., purchases, cash advances, etc.). Typically, each credit card reward program has its own incentives and rules that are complex and generally unknown to the consumer. When a consumer wants to conduct a given transaction, the consumer is often unaware which of the credit cards is most advantageous to use for the given transaction, i.e., provides the most incentive by way of reward benefits.

Some common incentives include a lower interest rate, rewards points for various purchases, airline mileage, or cashback. The number of rewards points earned by the consumer may also be increased for certain types of sales. For example, some credit cards may offer double points for groceries or gasoline. Credit cards may also offer coupons or other promotional benefits that are time sensitive.

Given the vast array of terms, rewards, and other offers, it is virtually impossible for consumers to keep track of which of the means of payment provide the consumer with the “best deal” for a given transaction. Consumers are often left to guess, at the point of sale, which of their various payment applications benefits the consumers the most for a given transaction. This indeterminate assessment often results in a consumer failing to optimize a given transaction. The number of cards that a user holds exponentially complicates matters. Accordingly, a need exists for a system that can detect the type of store and the classification of the merchandise in that store, so that the system recommends the most preferable credit cards for the consumer to use for each transaction.

### SUMMARY

According to an example, a computing device includes a location determinator having a position detector, a merchant information detector, and a category and/or sub-category detector. Additionally, the computing device includes one or more processors coupled to the location determinator, and one or more non-transitory computer-readable storage media embodying computer-readable instructions which, when executed by the one or more processors, are to: determine at least one of a category and/or a sub-category of a potential transaction based on information derived from the location determinator; retrieve account information of a plurality of payment applications; retrieve reward rules associated with each of the plurality of payment applications; associate each of the retrieved reward rules to the determined at least one of the category and/or the sub-category of the potential transaction; determine available rewards based on each of the retrieved reward rules, wherein each of the retrieved reward rules includes at least a primary reward rule, and wherein, to determine the available rewards, the one or more processors is configured to determine if the primary reward rule is valid for one or more of the plurality of payment applications. If the primary reward rule is valid, then generate a report for the one or more of the plurality of payment applications with a valid primary reward rule, wherein the generated report provides at least one of an amount of credit that is used or remains to achieve invalidation of the primary reward rule or an amount of time remaining prior to the primary reward rule becoming invalid; and if the primary reward rule for one or more of the plurality of payment applications is invalid, then ignore the primary reward rule for the one or more of the plurality of payment applications with an invalid primary reward rule and select a secondary reward rule for the one or more of the plurality of payment applications having the invalid primary reward rule; based on the determine available rewards, rank each of the plurality of payment applications; and communicate information of a selected one of the ranked payment applications to a point of sale terminal for the potential transaction.

In an example, the computer-readable instructions, when executed by the one or more processors, are to determine if one of a plurality of other payment applications includes a more advantageous reward rule for the determined at least one of the category and/or sub-category of the potential transaction compared to the retrieved reward rules.

In an example, to determine if one of the plurality of other payment applications includes the more advantageous reward rule, the computer-readable instructions, when executed by the one or more processors, are to at least one of: retrieve other reward rules associated with the plurality of other payment applications and compare the retrieved other reward rules associated with the plurality of other payment applications to the retrieved reward rules associated with each of the plurality of payment applications; and/or retrieve other reward rules associated with the plurality of other payment applications; and associate each of the retrieved other reward rules to the determined at least one of: the category and/or the sub-category of the potential transaction to determine other available rewards and compare the determined other available rewards with determined available rewards.

In an example, if one of the plurality of other payment applications includes a more advantageous reward rule, then the computer-readable instructions, when executed by the one or more processors, are to generate a recommendation to a user.

In an example, if one of the plurality of other payment applications includes a more advantageous reward rule, then the computer-readable instructions, when executed by the one or more processors, are to complete an application process for the one of the plurality of other payment applications using the retrieved account information of the plurality of payment applications.

In an example, if the primary reward rule is valid for one or more of the plurality of payment applications, the computer-readable instructions, when executed by the one or more processors, are to obtain a price associated with the potential transaction; wherein if the price of the potential transaction results in invalidating the primary reward rule, then the computer-readable instructions, when executed by the one or more processors, are to generate a new reward rule, wherein the new reward rule is based on an application of the primary reward rule to an amount of the price of the potential transaction that would invalidate the primary reward rule and the secondary reward rule for a remaining balance of the price of the potential transaction; and the computer-readable instructions, when executed by the one or more processors, are to rank each of the plurality of payment applications using the new reward rule.

In an example, when the retrieved reward rules include a non-cash reward, the computer-readable instructions, when executed by the one or more processors, are to determine equivalent reward cash value percentage of a cost of an item.

In an example, when the non-cash reward is in form of points, the computer-readable instructions, when executed by the one or more processors, are to convert the points into a nominal cashback based on the retrieved reward rules.

In an example, when the non-cash reward is in form of mileage, the computer-readable instructions, when executed by the one or more processors, are to convert the mileage into a nominal cashback based on the retrieved reward rules.

In an example, the position detector comprises at least one of a uniform resource locator (URL), cell phone towers, a global positioning system (GPS) device, a geomagnetic sensor, a local positioning system (LPS), a triangulation system, a trilateration system, a multilateration system, an indoor positioning system, a hybrid positioning system, a real-time locating system, or a dynamic positioning system.

In an example, the account information comprises at least one of identification number, expiration date, security number, name, address, phone number, electronic mail address, website address, income, spending habits, age of a consumer, credit limit, amount of credit that remains to reach a maximum reward cap of each of the plurality of payment applications, or time remaining until expiration of an initial offer.

In an example, the computer-readable instructions to rank each of the plurality of payment applications, when executed by the one or more processors, are further to rank, based on an inputted parameter, each of the plurality of payment applications.

According to another example of the invention, the inputted parameter comprises a user-defined goal.

In an example, the user-defined goal comprises at least one of nominal cashback, interest rate, points, or travel mileage.

In an example, the secondary reward rule of the one or more of the plurality of payment applications comprises a lower percent return on each sale.

In an example, comprising a reminder associated with parameters associated with at least one of primary reward rules or secondary reward rules for each of the plurality of payment applications.

In an example, the parameters comprise at least one of limited-time interest rate, special holiday rewards, or reaching a threshold spending amount within a predetermined time to receive a reward.

According to yet another example of the invention, the ranking of the plurality of payment applications is shown to a consumer for selection and the computing device receives an indication of selection of a payment application; and base on the selection of the payment application communicate information of a selected one of the ranked plurality of payment applications to a point of sale terminal for the potential transaction.

According to an example a method comprising one or more non-transitory computer-readable storage media embodying computer-readable instructions which, when executed by one or more processors, are to: retrieving reward rules associated with a plurality of accounts associated with one or more financial institutions; retrieving user financial information; and determining if the user qualifies for any of the plurality of accounts based on the retrieved user financial information; when the user qualifies for none of the plurality of accounts, based on the retrieved user financial information, provide the user with a recommended account at the one or more financial institutions; when the user qualifies for one of the plurality of accounts, provide the user with a platform for the user to apply for the one of the plurality of accounts; and when the user qualifies for more than one of the plurality of accounts, determine a best match account among the plurality of accounts, based on the retrieved user financial information and best reward associated with the plurality of accounts, and provide the user with the platform for the user to apply for the best matched account.

A computer readable medium embodying computer-readable instructions which, when executed by one or more processors, are to: determine at least one of a category or a sub-category associated with a merchant; retrieve account information of a plurality of payment applications; retrieve reward rules associated with each of the plurality of payment applications; associate each of the retrieved reward rules to the determined at least one of the category or the sub-category associated with the merchant; determine available rewards based on each of the retrieved reward rules, wherein, to determine the available rewards, the one or more processors is to: generate a report for the plurality of payment applications, wherein the generated report provides at least one of an amount of credit that is used or is available, or an amount of time remaining prior to invalidation of a reward rule; based on the determined available rewards, rank each of the plurality of payment applications; and communicate information of ranked payment applications to a point of sale terminal for the merchant

A technical problem includes determining, from a vast array of terms, rewards, and other offers, which of the means of payment provide a consumer with the “best deal” for a given transaction to thus optimize a given transaction. A technical solution to the technical problem includes detecting the type of store and the classification of the merchandise in that store and recommending the most preferable credit cards for the consumer to use for each transaction.

Additional features and advantages of various examples will be set forth, in part, in the description that follows, and will, in part, be apparent from the description, or may be learned by the practice of various examples. The objectives and other advantages of various examples will be realized and attained by means of the elements and combinations particularly pointed out in the description herein.

### BRIEF DESCRIPTION OF THE DRAWINGS

The drawings described herein are for illustration purposes only and are not intended to limit the scope of this disclosure in any way.

FIG. 1 is an illustration of three examples of credit card reward programs, according to an example;

FIG. 2 is a computing device, according to an example;

FIG. 3 is a flow chart of the overall system, according to an example;

FIG. 4 is a detailed flow chart of a comparison of the reward rules, according to an example;

FIG. 5 is a detailed flow chart of how to rank the reward rules of each credit card, according to an example;

FIG. 6 is a detailed flow chart of how the system determines whether any other available credit cards include a more advantageous rule than the credit cards in the virtual wallet, according to an example;

FIG. 7A is an illustration of a screenshot of a computing device when the system selects and uses of one of the credit cards in the virtual wallet, according to an example;

FIG. 7B is an illustration of a screenshot of a computing device when the system ranks the credit cards in the virtual wallet, according to an example; and

FIG. 8 is a flow chart of the overall system, according to an example.

Throughout this specification and figures like reference numbers identify like elements.

### DETAILED DESCRIPTION

It is to be understood that both the foregoing general description and the following detailed description are examples and explanatory only, and are intended to provide an explanation of various examples of the present teachings.

In the U.S., the average person has approximately 3.7 payment applications, such as credit cards, retail store cards, etc. The term “payment applications” herein refers to debit cards, gift cards, credit cards, retail store cards, and other products or services (e.g., cryptocurrency) that allow a consumer/user to use an account-based method to conduct a financial transaction, such as a purchase of a product or a service. The terms “payment applications” and “credit cards” may be used interchangeably herein to include debit cards, gift cards, credit cards, charge cards, retail store cards, and other products or services that allow a consumer/user to use a third party payment to complete a financial transaction, such as a purchase of a product or a service. The term “at least one of” herein should be interpreted as one or more of . . . . For example, at least one of A, B, C, and D should be interpreted as A or B or C or D or any combination thereof.

To attract business, payment applications issuers, such as credit or charge card issuers, provide different reward programs or incentives (hereinafter “reward rules” or “terms”). Generally, there may be a primary reward rule, which is applicable for a predetermined amount of time and/or requires the user of the payment application to use a predetermined amount of credit during that predetermined amount of time. Other examples of primary reward rule can include, but are not limited to, limited-time interest rate or special holiday rewards, to name a few. Once the predetermined amount of time (e.g., an introductory or a promotional period) has expired, the payment application issuers provide a secondary reward rule, which is usually not as beneficial as the primary reward rule. Moreover, the rewards, in both the primary and the secondary programs vary depending on the type of products or services that are purchased.

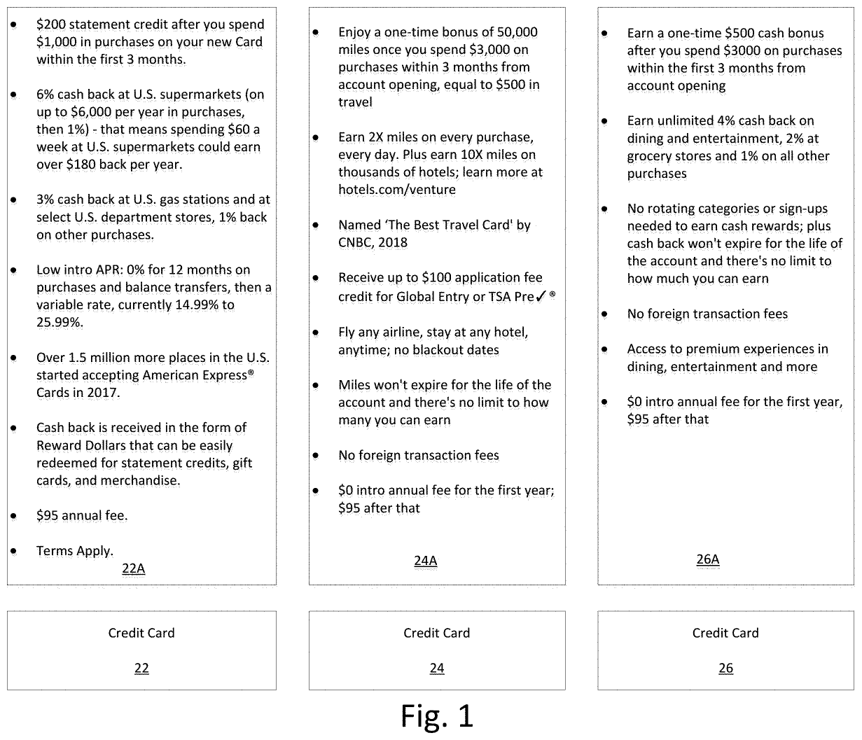

As an example, referring to FIG. 1, payment applications, such as credit cards 22, 24, and 26 are associated with corresponding reward rules/programs 22A, 24A, and 26A. As an example, credit card 22 can be an ARA Master Card, credit card 24 can be a Southwest Visa, credit card 26 can be an American Express charge card, or the like. For example, the primary reward rule 22A includes a $200 statement credit after the user spends $1,000 in purchases on a new credit card within the first three months. Thus, if a user spends $1000 of the credit line in the first three months of opening the credit card account, the user will receive approximately 20% back in statement credit. However, if the user does not spend $1000 of the credit line in the first three months of opening the account, the user may not receive any statement credit. Effectively, the user will receive 0% back. Moreover, most payment application companies open the account first and then several days or weeks later the user will receive his/her credit card, which reduces the three months period to spend the required $1000 of the credit line.

Thus, it is technically challenging to determine when the three-months deadline is approaching and the user has not used the requisite credit line to qualify for the primary reward benefits. In this regard, the apparatuses, methods, and non-transitory computer readable medium (storage media) disclosed herein address these technical challenges by generating an alarm when the three-months deadline is approaching and the user has not used the requisite credit line to qualify for the primary reward benefits.

Moreover, to complicate matters, some payment application rewards programs have a primary reward rule (and/or a secondary reward rule) that is not based on a cashback value. Instead, the rewards programs provide alternative valuations such as points or mileage. For example, referring to FIG. 1, the reward rules 24A corresponding to credit card 24 includes a one-time bonus of 50,000 miles once the user makes $3,000 of purchases within three months from opening an account. However, in most instances, the 50,000 miles does not equate to 50,000 actual miles of airplane travel distance. In practice, the 50,000 miles equates to (up to) a monitory value in travel credit. In this example, it will be equivalent to (up to) $500 in credit value.

Thus, another technical challenge is to compare two or more credit cards. In this regard, the apparatuses, methods, and non-transitory computer readable medium disclosed herein address these technical challenges by converting points or mileage into percent credit so that a person or the system can readily compare two or more credit cards.

Furthermore, when the primary reward rule expires (i.e., the primary reward rule is invalid), a secondary reward rule initiates. For example, the secondary reward rule that is associated with credit card 24 includes a 6% cashback at U.S. supermarkets (on up to $6,000 per year in purchases, then the rewards reduce to only 1%). In contrast, the secondary reward program of the reward rules 26A associated with credit card 26 includes unlimited 4% cashback on dining and entertainment, 2% at grocery stores and 1% on all other purchases. Thus, for example, if a user has not spent $6000 in purchases in one or more supermarkets, then it would be best for the user to use credit card 24 associated with reward rules/programs 24A; however, if the user has spent at least $6000 in a supermarket, then it would be best to use credit card 26 associated with the reward rules 26A.

Thus, it is technically challenging to determine which credit card to use to maximize the reward or value for each individual user under different circumstances. In this regard, the apparatuses, methods, and non-transitory computer readable medium disclosed herein address these technical challenges by tracking use of the line of credit in different stores and determining which payment application to use at which stores to optimize and maximize the reward or value for each individual user under what circumstances.

Additionally, the user may not have a payment application that maximizes the user's return based on the stores and/or services that user frequents. Thus, a need exists for a system to also determine and recommend the most beneficial payment application. Moreover, some people find the application process for a credit card too time-consuming. Thus, a need also exists to automate the application process and card recommendation.

The system of the present invention provides a technological solution to all the above-identified technological challenges.

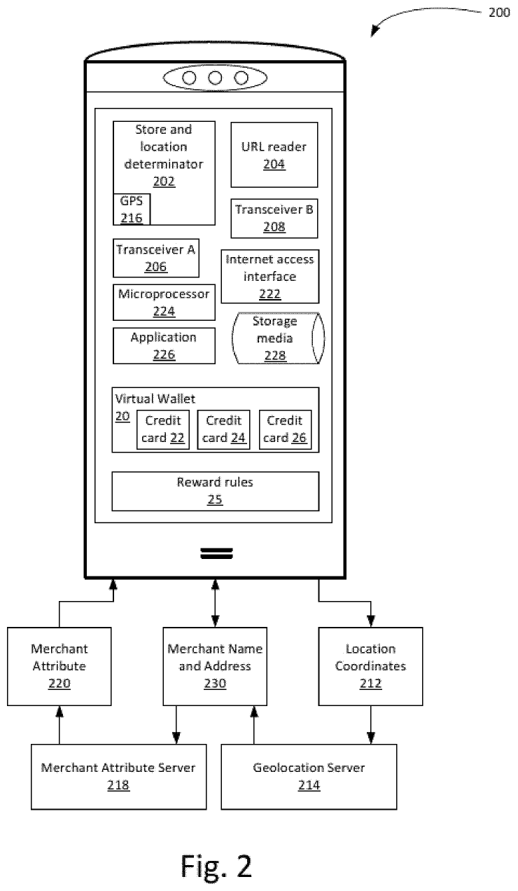

In an example, the system may include a computing device 200, shown in FIG. 2. In an example, the computing device 200 may be any device that includes one or more processors 224 and one or more non-transitory computer-readable storage media 228 embodying computer-readable instructions which, when executed by the one or more processors, allow a user to purchase a product or a service. In an example, the computing device 200 may be a mobile device.

The computing device 200 may include a location determinator 202 that is able to determine its current geolocation and store the geolocation and the information of a store corresponding to that geolocation. Furthermore, the computing device 200 may include a uniform resource locator (URL) reader 204, an internet access interface 222, an application 226, a virtual wallet 20, and reward rules 25.

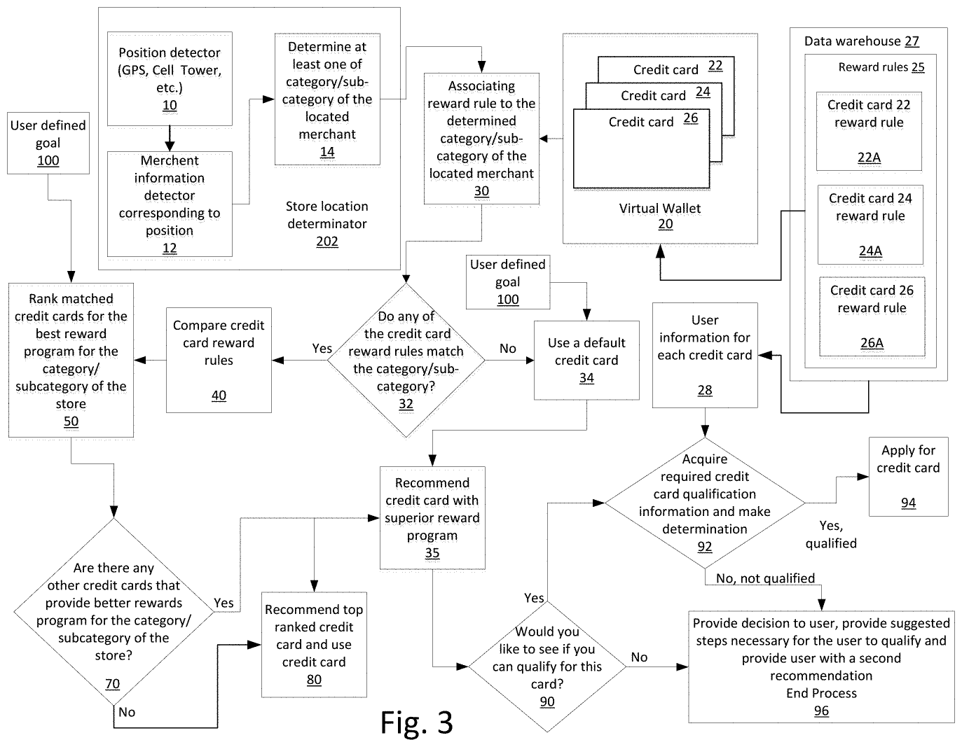

The systems and/or programs illustrated in FIGS. 3-6 and 8, may be processed locally on the computing device 200 or may be processed in a cloud or another computing system. Thus, although the description below references computing device 200, when applicable, the system and programs illustrated in FIGS. 3-6 and 8 may not be processed on the computing device 200. Instead, they may be processed on a cloud or on another computing system.

FIG. 3 is a flow chart that illustrates how the system may (i) recommend which of the plurality of payment applications to use in a particular store to obtain the maximum reward, (ii) recommend a new credit card, which will provide the user with better rewards than the user's current credit cards, (iii) submit the user's information to qualify the user for the new credit card, (iv) provide an alarm or a notice when a reward-based deadline is approaching, (v) convert points or mileage to a nominal reward cashback value, and (vi) track an accumulated amount of credit used in each store or a category of stores.

Referring to FIGS. 2 and 3, the computing device 200 of the system or a cloud computing system (not shown in the figures) may include a virtual wallet 20 and reward rule 25. The virtual wallet 20 may include one or more payment applications, such as credit card 22, credit card 24, and credit card 26. In one example, credit card 22 can be an ARA Master Card, credit card 24 can be a Southwest Visa, and credit card 26 can be an American Express. An owner of the computing device 200 may enter the information regarding each of his/her credit cards 22, 24, and 26 in the virtual wallet 20.

Additionally or alternatively, the user of the computing device 200 may download an application 226 (in a form of a set of instructions being executed by the processor 224) that allows a user to retrieve/obtain and/or store the reward rules 22A, 24A, and 26A corresponding to each of the credit cards 22, 24, and 26 in the virtual wallet 20 or reward rules corresponding to credit cards not presently in the virtual wallet 20. The computing device 200 through application 226 may be able to retrieve such information from the payment application issuers/providers and/or the respective loyalty program providers, or other sources. Once the application 226 has been downloaded and, optionally, the user has entered his/her credit cards information into the virtual wallet 20, the computing device 200, through application 226, may determine available rewards by obtaining and/or requesting from a system (e.g., credit card system or bank system associated with the credit card) to receive an updated copy of the reward rules 25, such as reward rules 22A, 24A, and 26A associated with each of the credit cards 22, 24, and 26 in the virtual wallet 20. In another example, the computing device 200 may request to obtain and/or receive a copy of an updated copy of the reward rules associated with credit cards that do not appear in the virtual wallet 20 in addition to or in lieu of the reward rules 22A, 24A, and 26A associated with each of the credit cards 22, 24, and 26 in the virtual wallet 20.

In an example, the reward rules 25 may periodically store the obtained/retrieved reward rules 25 in the computing device 200, on a server, or on a cloud. In an example, the computing device 200 can sort the plurality of payment applications in accordance with their corresponding reward rules and with respect to a predicted payment transaction or predicted payment transaction type that is to be made in a transaction terminal. Optionally, the sorting of the payment application also considers the inputted user-defined goals 100.

In an example, the reward rules 25 and any updates of the reward rules may be saved in a data warehouse 27. The data warehouse 27 can also store transaction data recording the payment transactions processed by a transaction handler in an electronic payment processing network and other relevant information such as the account opening date. As will be discussed in detail below, by storing the transaction, the system can determine if the term conditions for receiving the rewards associated with the primary reward have been met.

In an example, to determine which payment application of the plurality of payment applications provides the most benefits in a specific store, the system may predict a payment transaction and/or predict payment transaction type and information associated with the store in which the payment transaction may take place. In an example, the system may predict the payment transaction and its associated information based on the location of the computing device 200 and an analysis of the user's purchasing habits, either generally or in a particular store. This location can be a physical location of the computing device 200 or a virtual location (e.g., if a user is on a website of ABC and may be thinking about purchasing a product).

In an example, if a user would like to purchase a pair of pants from ARA store in the mall at Tysons Corner, Va., the computing device 200 may include a store location determinator 202 that is able to determine the current physical location of the computing device 200, the corresponding information about the merchant (in this case the ARA store) in that location, and the corresponding category and/or sub-category of the store. The store location determinator 202 can include a position detector 10. The position detector 10 can be in the form of a global positioning system (GPS) receiver 216 configured to receive GPS signals from GPS satellites and/or similar signals from base stations. Other location determination techniques can also be used. For example, the position detector 10 of one example may be able to determine its position based on signals from base stations/towers for cellular communications, and/or signals from access points of wireless local area networks (WLAN) (e.g., triangulation). Other devices, systems or methods that a position detector 10 can utilize, include, but are not limited to, a uniform resource locator (URL) reader, a geomagnetic sensor, a local positioning system (LPS), a trilateration system, a multilateration system, an indoor positioning system, a hybrid positioning system, a real-time locating system, or a dynamic positioning system.

The position detector 10 may then determine the location coordinates 212 of the computing device 200. For example, when the user arrives at the ARA store in Tysons Corner, Va., the position detector 10 can determine that the computing device 200 is at coordinates 38.918351, −77.221742. The merchant information detector 12 can then look up the merchant and corresponding merchant attributes based on the provided location coordinates 212 (e.g., coordinates 38.918351, −77.221742). The computing device 200 may also include at least one internet access interface 222 for communication with remote servers. Examples of such an internet access interface 222 include a cellular communications transceiver, a wireless local area network transceiver, etc.

To identify the merchant and corresponding merchant attributes, the merchant information detector 12 may communicate with a geolocation server 214 that provides Application Programming Interfaces (API). The API submits location coordinates 212 of the current location of the computing device 200 and retrieves various information about that location, such as the name and address 230 of a merchant that contains the location, the type of credit card accepted by the merchant and any coupons or promotional codes that is accepted by the merchant. For example, the APIs of Google Places accept the latitude and longitude as inputs to obtain the name and address of the business at the location. In the example, the corresponding name and address of the business at coordinates 38.918351, −77.221742 may be 1961 Chain Bridge Rd., Tysons Corner, Va.—VA 22102. Alternatively or additionally, if a user of the computing device 200 is not in a store, the API submits location coordinates 212 of the current location of the computing device 200 and retrieves various information about that location, such as the name and address 230 of a merchant or merchants that are near the location of the computing device 200 and may retrieve various information about the merchants near that location, such as the name and address 230 of merchants near that location, type of credit cards accepted by the merchants and may also provide coupons or promotional cods associated with each of the merchants.

To determine the category and/or sub-category 14 of a merchant, a merchant attribute server 218 may store a table to look up the merchant attribute 220, such as the merchant category code (MCC) of the merchant identified by the merchant information detector 12. Such information can include, merchant name and address. For example, the APIs of Visa or Mastercard Supplier Locator can provide the MCC of 5651 and 5691 relating to a family clothing store and men's and women's clothing stores for “ARA” and “1961 Chain Bridge Rd., Tysons Corner, Virginia.—VA 22102”. Moreover, the system may be able to determine or estimate the amount which the user will spend in the ARA store based on the analysis of the user's transaction history at the ARA store or similar stores over a particular period (e.g., Christmas shopping season, etc.).

In some examples, the computing device 200 may postpone the determination of category and/or sub-category until a communication session with a transaction terminal is about to be initiated using the short range transceiver 206, long range transceiver 208, or during the initiation of the communication session with a transaction terminal.

In one example, in addition to or in the alternative, to use the store and location determinator 202, the most likely transaction terminal is determined further based on the communication history of the computing device 200 with different transaction terminals. As discussed in detail below, the computing device 200 may store reward rule details in association with various categories and/or subcategories. In an example, the reward rule details of each payment application can be stored on a server or the computing device 200.

In another example, if a user is purchasing a product or a service online, then the type and specific store can be determined by its URL. In the example, the position detector 10 can be in the form of a URL reader 204. In this case, when the user goes on the ARA web site, the URL reader 204 can detect that the user is on the ARA website and may be purchasing a product from ARA. The system can then derive the merchant information and determine the category and/or sub-category of the merchant based on the determined URL.

In one example, the computing device 200 monitors its current location determined by the position detector 10 such as the GPS 216 or the URL reader 204. When the current location of the computing device 200 has changed from the location previously communicated to the geolocation server 214, the computing device 200 can repeat the above process to update the merchant attribute 220, the merchant name and address 230, and the category and/or sub-category 14. In the example where a user is browsing a website, once the primary URL changes, for example, from ARA.com to ZZZ.com, then the URL reader 204 updates the merchant attribute and name and addresses based on the updated URL.

Once the category and/or sub-category 14 of the located merchant has been determined, then at 30, the system can compare the category and/or sub-category of the merchant to each of reward rules 22A, 24A, and 26A corresponding to the credit cards 22, 24, and 26 in the virtual wallet 20, respectively. For example, the system can create a table of the credit rules and place the category and/or sub-category on the table to determine if there is a match. For example, the given that the ARA store is a clothing store, the reward rules 22A, 24A, and 26A corresponding to the user's ARA Master card (credit card 22), Southwest Visa (credit card 24), and American Express (credit card 26) all provide rewards towards spending money on clothing (i.e., MCC of 5651 and 5691). Thus, the system, at 32, determines a match between the reward rules 22A, 24A, and 26A and the merchant (ARA Store) category.

Thus, the system compares the reward rules of each credit card to determine which credit card provides the best reward. However, if none of the credit cards provided rewards toward spending money on clothing, then at 34 a default credit card may be selected to purchase the clothing. In this example, the default credit card can be either by a user-defined goal or inputted parameters 100 (such as the credit card with the lowest interest rate) or the system can set up a default credit card by analyzing the user's spending habits, as described below. In the example, where a default credit card is selected because the credit cards in the virtual wallet 20 doesn't provide any benefits for the particular category of merchandise of interest to the user, the system, at 35, can recommend/suggest applying for a new credit card with more advantageous reward rules based on the user's purchasing habits as described below in detail.

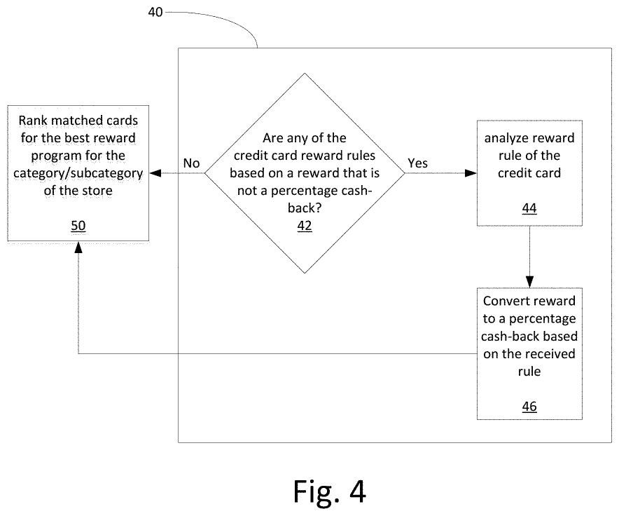

Referring to FIGS. 3 and 4, to compare the reward rules, at 40, the system may first determine if any of the rewards associated with any of the credit cards is based on a non-cash return (e.g., points or airline mileage). In this example, at 42, the system, based on the review of the reward rules 24A, determines that the Southwest Visa is not based on the nominal cash return. Thus, the system needs to determine the corresponding cash return percent of the reward mileage of the reward rules 24A. In this regard, at 44, the system can conduct an analysis of the reward rules 24A to determine if the reward rules 24A provides any information about the cash equivalent of the mileage reward. In this example, the primary mileage reward is if the user spends $3000 he/she will receive 50,000 miles, which as a value of no more than $500. Thus, at 46, the application 226 converts the mileage to a nominal cash back for the primary reward as being approximately 17%. However, the secondary reward is two times the mileage for every dollar spent except if the credit card is used on booking hotels. Thus, at the ARA store, the user will only receive an equivalent cashback value of 2%.

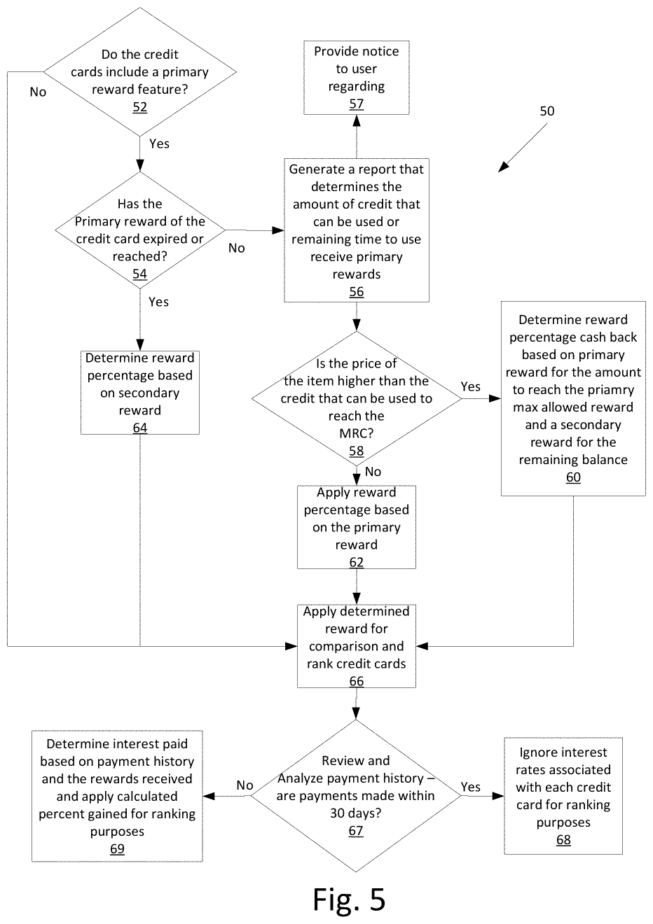

Referring back to FIGS. 3 and 5, at 50, once the system has converted the mileage to a nominal cashback value, the system compares the reward program for each of the three credit cards 22, 24, and 26. However, given that each of credit cards 22, 24, and 26 is associated with a reward rule that includes at least a primary reward and a secondary reward, the system may first determine if the primary or the secondary reward applies to each of the credit cards. To determine which reward type is to be used, the system, at 52, determines if any of the reward rules includes a rule that limits the reward feature. Such a rule can be a timeline, a maximum reward cap, a combination of a timeline and amount of the credit line to be used.

For example, referring to FIG. 1, reward rule 22A associated with credit card 22 includes a $200 statement credit after the user spends $1,000 in purchases on the card within the first three months. Reward rules 24A associated with credit card 24 includes a one-time bonus of 50,000 miles once the user spends $3,000 on purchases within 3 months from opening an account. Finally, the reward rules 26A associated with credit card 26 includes earning a one-time $500 cash bonus after you spend $3000 on purchases within the first 3 months from account opening. Accordingly, all three cards include a primary reward rule that expires within three months of opening an account (i.e., all three cards include a primary reward rule that is valid for three months from the date in which the user opened an account).

Referring to FIG. 5, at step 54, the system may determine if any of the reward-limiting features in the reward rule has been satisfied. For example, with respect to credit card 22, which is associated with reward rules 22A, if the user has spent $1000 or more, then at 64, the system will determine that the primary reward rules are invalid (i.e., no longer valid) and, at step 66, the system will apply the secondary rewards rules for comparison and ranking purposes. Moreover, if the $1000 maximum limit has not been reached, but the three months deadline from the opening of the account has passed, then, at 64, the system again will determine that the primary reward rules are invalid and, at 66, the system will apply the secondary rewards for comparison and ranking purposes.

In order for the system to determine the amount of money spent or to determine if the timeline has passed, the system can request or retrieve the required information, such as date of opening the account or the amount spent since opening an account from the data warehouse 27, the credit card account of the user, or any other secure storage that contains such user information 28 for each of the credit cards.

Moreover, if the system, at 52, determines that one or more of the credit cards does not have two-tier reward rules (i.e., primary reward rule and secondary reward rule) then, at 66, for comparison and ranking purposes, the system will use the reward rules as if the primary reward rules had been reached or expired.

In an example, if, at 54, the system determines that the reward-limiting features in the reward rules of at least one of the credit cards has not been reached, then, at 56, the system generates a report. The report can then be provided to the user in a form of a notice 57 that allows the user to update a user-defined goals 100 to use the credit card associated with the primary rewards as the user's default card. In an alternative example, the system can update the user-defined goals 100 and make the credit card with valid primary reward rules to be the default credit card until the maximum allowed amount has been reached or the primary rewards time has expired. Once the maximum amount of spending for receiving the primary rewards or the primary rewards time has expired, the system can determine which credit card should be used as the default credit card. The selection of the next default credit card can be based on a pattern of user spending and the credit card that provides the most secondary benefits based on the user's spending habits.

The system can either select that next default credit card or generate a recommendation in the form of a notice 57 to the user. In another example, if the user has a plurality of credit cards with a valid primary reward rule, then the system can compare the primary rewards and determine which credit card to use. Alternatively, the system can determine the credit card that has a primary reward expiration or invalidation date that is soon approaching and/or the user needs to spend the most amount of money to receive the primary rewards. Once the maximum amount of spending for receiving the primary rewards has been reached or the primary rewards time has expired, the system can select the next card that still has a valid primary reward rule with an approaching primary reward expiration/invalidation date as the default credit card or can make a recommendation in the form of a notice 57 to the user as to which credit card should be used as a default credit card.

The system can also make an estimation, based on the user's previous transactions, as to when the user is projected to reach the necessary spending amount to receive the maximum rewards of the primary rewards. Based on the user's transaction history analysis, the system can recommend a new credit card or designate a default credit card.

The system at 58 can determine if the price of the merchandise to be purchased at a particular store (for example, at ARA) will be higher or lower than the amount in which the primary rewards cap. Given that the system is aware which store that the user is located (e.g., ARA) the system, at 58, can determine that, based on an analysis of the user's spending habits, the user usually spends about $300 at the ARA store. Alternatively, the system can determine the price of the merchandise during the initiation of the communication session with the transaction terminal.

In an example, if the system, at 58, determines that the price of the merchandise is higher than the remaining amount to reach the maximum primary reward associated with credit card 22, then the system, at 60, determines the nominal back based on the primary reward and the secondary reward. For example, if it is determined that the price of the merchandise is $300; however, for credit card 22, to reach the maximum of the primary reward the user only needs to spend $5, then at 60, the system determines a new nominal cash back associated with credit card 22 that is based on the primary reward rule for $5 of the $300 and the secondary reward rule for the remaining $295. This new calculated nominal cash back for credit card 22 can be used, at 66, to compare and rank the reward programs of all of the user's credit cards 22, 24, and 26.

If however, at 58, the system determines that the price of the merchandise is lower than the remaining amount to reach the maximum primary reward associated with credit card 22, then the system, at 62, determines that the primary reward rule should apply to credit card 22 and, at 66, the primary reward rules of credit card 22 are used to compare and rank the reward programs of all the user's credit cards 22, 24, and 26.

Referring to FIG. 3, in an example, the user may define a goal or goals 100. For example, if the user knows that he/she is unable to pay off the credit card bill within 30 days and, as such, he or she will incur interests, which may be higher than any nominal reward, then the user may provide the system with a user-defined goals 100 to request the system to rank the credit cards with respect to their respective interest rates. Alternatively, the user may assign a value to each benefit of each credit card for ranking purposes. For example, if the user prefers to use a credit card with a lower interest rate, then the user can set a higher value on the low-interest rate and a lower value to the high nominal cashback. Thus, if credit card 22 has an interest rate of 25% and a percent cashback of 6% and credit card 26 has an interest rate of only 10% and a percent cashback of 2%, the user may assign a higher value to the interest rate of 10% of the credit card 26 and a lower value to the percent cashback of 6% of the credit card 22. Alternatively or additionally, the user can ask the system to consider the credit card interest rate in conjunction with the reward rules when ranking the credit cards.

In an example, based on the user's credit card payment history, the system can consider the interest rate of each credit card in addition to the credit cards' primary and secondary benefits when ranking the credit cards. For example, referring to FIG. 5, at 66, when the system has determined the nominal return of each credit cards 22, 24, and 26, the system can then review the user's credit card payment history for each of credit cards 22, 24, and 26 and determine the cost-benefits of using a credit card with higher reward rules and a higher interest rate versus a credit card having a lower interest rate and a lower reward rules. For example, at 67, the system can analyze the user's payment history for a predetermined amount of time. For example, the system can analyze the payment history on the previous month, previous two months, previous quarter, previous six months, previous year or since the user obtained the credit card. If the user has a history of paying-off his/her credit cards within 30 days, then the system, at 68, can ignore the interest rate associated with the credit cards and compare only the primary and secondary rewards, when applicable. However, if the user has a history of paying off the credit card bill every 90 days, for example, then, at 69, the system will consider if the interest rate based on a 90-day delay nullifies the benefit of each credit card. Based on such analysis, the system will then rank each credit card.

In an example, credit card 22 has an interest rate of 26% annual percentage rate (APR) and according to the reward rules 22A it provides a 3% cashback on purchasing gas. Credit card 26 has an interest rate of 10% APR and according to the reward rules 26A it only provides a 1% cashback on purchasing gas. According to the rules of both credit cards 22 and 26, the user may need to make a minimum payment of 2% each month. Moreover, the analysis of the user's payment history determines that the user pays off gas purchases of $100 in four months by paying approximately $30 per month to pay off the $100 of gas purchase. Accordingly, the system determines that if credit card 22 is used to pay for the gas, the total interest paid to pay off the $100 gas bill would be $5. However, if credit card 22 is used to purchase $100 of gas, the reward rules 22A associated with credit card 22 provides a 3% cashback (i.e., $3). As such, by using credit card 22, the user will have a net loss of $2. In contrast, the system determines that if credit card 26 is used to pay for the gas, the total interest paid to pay off the $100 gas bill would be $1.87. However, if credit card 26 is used to purchase $100 of gas, the reward rules 26A associated with credit card 26 provides a 1% cashback (i.e., $1). As such by using credit card 26, the user will have a net loss of only $0.87. Thus, in this example, the system will rank credit card 26 higher than credit card 22 for this particular user purchasing gas.

In another example, if the analysis of the user's payment history determines that the user pays off gas purchases of $100 within 30 days, then the system determines that the user in this example will likely not incur any interest. Thus, the system will rank credit card 22 higher than credit card 26.

In an example, once the ranking of the credit cards 22, 24, and 26 has been completed, the system, at 70, can determine if any other credit cards, not in the virtual wallet 20, may include more beneficial reward rules for the particular merchant or category of merchants detected by the system. Alternatively or additionally, the system can analyze the purchase history of the user of the system and determine a merchant or category of merchants where the user spends the most amount of money on a monthly, quarterly, or yearly bases. Based on this determination, the system, at 70, can determine if any other credit cards, not in the virtual wallet 20, may include more beneficial reward rules in relation to the merchant or category of the merchant where the user spends the most amount of money.

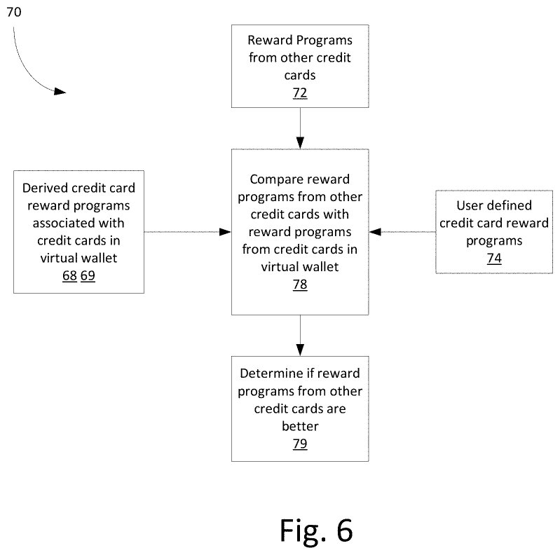

Referring to FIG. 6, to determine if any other credit cards, not in the virtual wallet 20, may include more beneficial reward rules for the particular merchant or category of merchants detected by the system, the reward rules from other credit cards 72 may be accessed or imported. For example, the reward rules for the other credit cards may be in the data warehouse 27 or can be imported into the data warehouse 27 from the different credit card issuers. At 78, the reward rules for each of the other credit cards 72 can then be compared to the determined reward programs, derived at 68 or 69 of credit cards in the virtual wallet 20 (e.g., credit cards 22, 24, and 26) to determine if any of the other credit cards include more advantageous reward rules. In one example, the reward rules of the other credit card can be compared to the determined rewards at 68 or at 69 of the credit cards in the virtual wallet 20. At 78, based on the comparison of the reward programs, including, but not limited to the interest rates, the system can determine if any other credit cards have a more advantageous reward rule for a particular store or category. At 79, the system 70 can determine if reward programs from other credit cards are more advantageous for the user. If at 79 it is determined that one or more of the other credit cards, not in the wallet, may include a more advantageous reward rule for the user, then at 35, a suggestion or recommendation can be provided to the user.

In another example, in addition to or in an alternative to comparing the reward programs, the system can compare reward programs based on a user's payment habits or spending habits. In an example, at 74, the user can define its own desired reward program. For example, the user can request that the system only selects a credit card that has the lowest interest rate or a credit card that has the highest % cashback. The user can also, at 74, define the credit card reward, such that the interest payment is a non-issue. That is the user can ask the system to ignore the credit card interest rates all together because the user is not going to pay off the credit card prior to credit accruing any interest or administration fees.

If the system, at 70, determines that no other credit card includes a more beneficial reward rules in relation to the particular merchant or category of merchants detected by the system or the merchant or category of merchants where the user spends the most amount of money, then, at 80, the system can either select the top-ranked credit card to use for a transaction or can provide the user with its recommendation for the user to accept or deny.

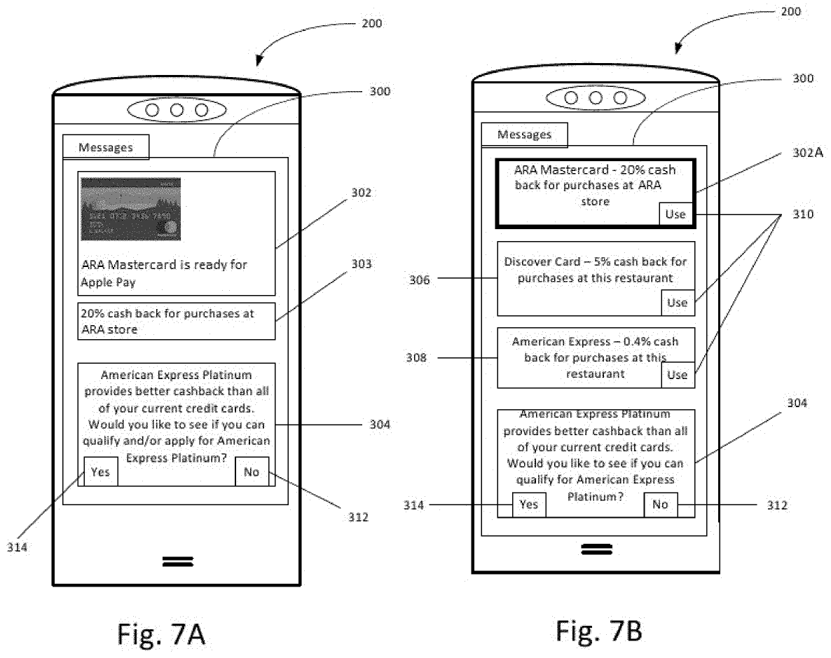

FIG. 7A illustrates an example of when the system selects the top-ranked credit card. For example, if a user has an ARA Master card and the system determines that the user is at an ARA store, the system after comparing the rewards rules of all the cards in the virtual wallet, may determine that ARA Mastercard provides the best benefits at the ARA store. Thus, the display 300 will open a window 302 that states ARA Mastercard is ready for Apple Pay®. Optionally, the open window 302 will also display a message stating the nominal cash back associated by using the ARA Master card. In an example, this optional message will not be displayed in the open window 302, but instead, will be displayed in a second open window 303.

If the system, at 70, determines that another credit card includes more beneficial reward rules in relation to the particular merchant or category of merchants detected by the system or the merchant or category of merchants where the user spends the most amount of money, then the system, at 80, can select the top-ranked credit card to use for a transaction and/or can provide the user with its recommendation and a user interface for the user to accept or deny. In such a case, referring to FIG. 7A, the display 300 can open a third window 304 that provides further details about the other credit card with more beneficial reward rules and provides the user with the option to see if the user would like to see if the user qualifies for this suggested credit card by clicking on the “Yes” button 314 or if not interested clicking on the “No” button 312. In one example, based on the previously owned credit cards or the user information provided to the system, the system can simply provide a list of pre-qualified suggested/recommended credit cards. In such an example, the user by clicking on the “Yes” button 314 will allow the system to apply to that credit card.

FIG. 7B illustrates the computing device 200, wherein the system simply ranks the credit cards based on their reward program and allows the user to select the one that the user prefers. In this example, each of the ranked credit cards can be displayed on a separate window, such as windows 302A, 306 and 308. Moreover, each window associated with a credit card will include a “Use” button 310 that would allow a user to select with a credit card to use. Similar to FIG. 7A, if a credit card includes a more beneficial reward rule, the system can suggest that credit card in another window 304. In this example, when the user can select one of the credit cards by simply taping on the use buttons 310 associated with a specific credit card that the user would like to use. Based on the selection of the credit card (i.e., payment application), the computing device 200 may communicate the information of the selected credit card to a point of sales terminal for a potential transaction.

Referring back to FIG. 3, when the system provides a recommended/suggested credit card, in one example, the system, at 90, can ask if the user would like to know if the user would qualify for the recommended/suggested credit card. If the user responds in the negative, then the process would end at 96. However, if the user responds in the affirmative, then at 92, the system would access or retrieve user information 28 and use such information to determine if the user would qualify for the recommended/suggested credit card. If the system determines that one or more pieces of the information is incomplete to determine if the user will qualify for the recommended/suggested credit card, then the system would ask that the user provide the system with such information.

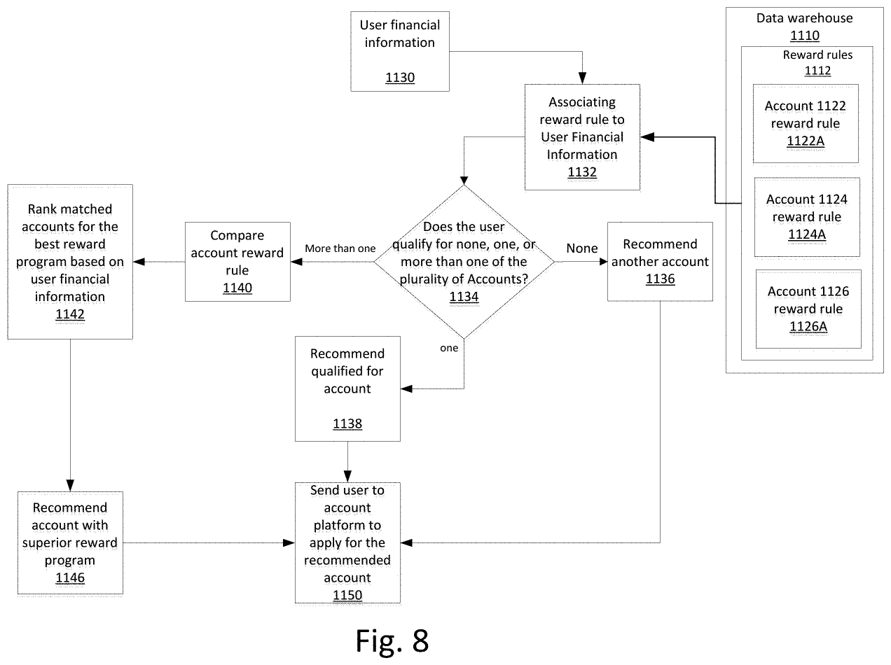

Referring to FIGS. 2 and 8, the computing device 200 or a cloud computing system (not shown in the figures) may download an application (in a form of a set of instructions being executed by the processor 224) that allows a user or the system to retrieve/obtain and/or store the reward rules 1122A, 1124A, and 1126A corresponding to each of financial account form (e.g., savings account) 1122, 1124, and 1126 advertised by one or more financial institutions.

The computing device 200 or the cloud computing system, through the downloaded application, may request the financial institution or other sources to send the reward rules 1122A, 1124A, and 1126. Additionally, or alternatively the computing device 200 or the cloud computing system can request for a permission to access and retrieve such information from the financial institution or other sources. Once the application has been downloaded and, optionally, the user has entered his/her financial information 1130 or the application has downloaded or has retrieved the user's financial information 1130, the computing device 200, through application may obtain and/or request to receive an updated copy of the reward rules 1112, such as reward rules 1122A, 1124A, and 1126A associated with each of the plurality of financial accounts 1122, 1124, and 1126.

In an example, the reward rules 1112 may periodically store the obtained/retrieved reward rules 1112 in the computing device 200, on a server, or on a cloud. In an example, the computing device 200 can sort the plurality of account information in accordance with their corresponding reward rules and with respect to the user's financial information 1130 and, thus, the user's financial qualifications. In an example, the account information and/or financial information 1130 can include one or more of the following information: identification number, expiration date, security number, name, address, phone number, electronic mail address, website address, income, spending habits, age of a consumer, credit limit, amount of credit that remains to reach a maximum reward cap of each of the plurality of payment applications, or time remaining until expiration of an initial offer.

In an example, the reward rules 1112 and any updates of the reward rules may be saved in a data warehouse 1110. The data warehouse 1110 can also store the user's financial information 1130, such as user's spending habits, savings account, average monthly savings, etc. as described above and/other information necessary to open a new financial account. At 1132, the financial information 1130 may be compared to the reward rules 1112. For example, the reward rule 1122A may require a user to have at least $10,000 in his/her account for at least three months. The processor 224 can associate this requirement with the user financial information 1130. At 1134, if the processor 224 concluded that the user may not qualify for any of the plurality of accounts 1122, 1124, or 1126, then at 1136, the processor may suggest another type of account that the user may qualify to open. At 1134, if the processor 224 concluded that the user may only qualify for one of the plurality of accounts 1122, 1124, or 1126, then at 1138, the processor may suggest the user to apply for the qualified account. At 1134, if the processor 224 concluded that the user may qualify for more than one of the plurality of accounts (for example all of the accounts 1122, 1124, and 1126), then at 1140, the processor may compare the reward rules 1122A, 1124A, and 1126A of each of the qualified accounts 1122, 1124, and 1126. At 1142, the processor 224 may rank each of the qualified for accounts 1122, 1124, and 1126 based on their respective reward program. At 1146, the processor may suggest the user to apply for the qualified account that provides the best rewards for the user. In an example, if the user needs to or is interested in opening more than one account, the user can communication his/her interest in opening a plurality of accounts via user interface. In this example, the system can then provide the user with a list of predetermined number of plurality of accounts that have the best reward programs. The system may also provide certain information to the user to take advantage of the reward program. For example, the system may let the user know how much he/she needs to put into each account in order to take advantage of the reward associated with each account.

In an example, after an account has been recommended at 1136, 1138, and 1146, at 1150, the processor can navigate the user to an account application webpage or platform. In an example, the system can complete the account application by utilizing the information retracted from the user financial information or other information on the computing device 200. Once the account has been formed, the user may make the necessary deposit within a predetermined number of days. In another example, the system can securely transfer the necessary amount from a user account to the newly created account.

After the qualification process has been completed, if the system determines that the user would not qualify for such a credit card, then the system, at 96, may do at least one of the following: provide the information to the user, suggest steps that the user can take in order to qualify for the recommended/suggested credit card, and recommend/suggest a second credit card that the user would qualify for. The process would then end. If the system determines that the user would qualify for the recommended/suggested credit card, then, at 94, the system would apply, on behalf of the user, for the recommended/suggested credit card by using the information obtained to confirm that the user will qualify to obtain the recommended/suggested credit card. Alternatively, the system can ask to confirm that the user would like to apply to the recommended/suggested credit card prior to the system applying for the credit card.

In another example, the user can simply request the system to provide a recommended/suggested credit card if the system determines that the recommended/suggested credit card includes a more advantageous reward rule and to apply for the recommended/suggested credit card.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

We claim:

1. A computing device comprising:
a location determinator including:
a position detector;
a merchant information detector; and
a category or subcategory detector;
one or more processors; and
one or more non-transitory computer-readable storage media embodying computer-readable instructions which, when executed by the one or more processors, are to:
determine at least one of a category or a sub-category of a potential transaction based on information derived from the location determinator;
retrieve account information of a plurality of payment applications;
retrieve reward rules associated with each of the plurality of payment applications;
associate each of the retrieved reward rules to the determined at least one of category or the sub-category of the potential transaction; and
determine available rewards based on each of the retrieved reward rules,
wherein each of the retrieved reward rules includes at least a primary reward rule, and
wherein, to determine the available rewards, the one or more processors is configured to:
determine if the primary reward rule is valid for one or more of the plurality of payment applications;
if the primary reward rule is valid, then generate a report for the one or more of the plurality of payment applications with a valid primary reward rule, wherein the generated report provides at least one of an amount of credit that is used or remains to achieve invalidation of the primary reward rule or an amount of time remaining prior to the primary reward rule becoming invalid; and
if the primary reward rule for one or more of the plurality of payment applications is invalid, then ignore the primary reward rule for the one or more of the plurality of payment applications with an invalid primary reward rule and select a secondary reward rule;
based on the determined available rewards, rank each of the plurality of payment applications; and
communicate information of a selected one of the ranked plurality of payment applications to a point of sale terminal for the potential transaction.

2. The computing device of claim 1, wherein the computer-readable instructions, when executed by the one or more processors, are to determine if one of a plurality of other payment applications includes a more advantageous reward rule for the determined at least one of the category or sub-category of the potential transaction compared to the retrieve reward rules.

3. The computing device of claim 2, wherein to determine if one of the plurality of other payment applications includes the more advantageous reward rule, the computer-readable instructions, when executed by the one or more processors, are to at least one of:
retrieve other reward rules associated with the plurality of other payment applications and compare the retrieved other reward rules associated with the plurality of other payment applications to the retrieved reward rules associated with each of the plurality of payment applications; or
retrieve other reward rules associated with the plurality of other payment applications; and associate each of the retrieved other reward rules to the determined at least one of: the category or the sub-category of the potential transaction to determine other available rewards and compare the determined other available rewards with determined available rewards.

4. The computing device of claim 2, wherein if one of the plurality of other payment applications includes a more advantageous reward rule, then the computer-readable instructions, when executed by the one or more processors, are to generate a recommendation to a user.

5. The computing device of claim 2, wherein if one of the plurality of other payment applications includes a more advantageous reward rule, then the computer-readable instructions, when executed by the one or more processors, are to complete an application process for the one of the plurality of other payment applications using the retrieved account information of the plurality of payment applications.

6. The computing device of claim 1, wherein if the primary reward rule is valid for one or more of the plurality of payment applications, the computer-readable instructions, when executed by the one or more processors, are to obtain a price associated with the potential transaction;
wherein if the price of the potential transaction results in invalidating the primary reward rule, then the computer-readable instructions, when executed by the one or more processors, are to generate a new reward rule, wherein the new reward rule is based on an application of the primary reward rule to an amount of the price of the potential transaction that would invalidate the primary reward rule and the secondary reward rule for a remaining balance of the price of the potential transaction; and
the computer-readable instructions, when executed by the one or more processors, are to rank each of the plurality of payment applications using the new reward rule.

7. The computing device of claim 1, wherein when the retrieved reward rules include a non-cash reward, the computer-readable instructions, when executed by the one or more processors, are to determine equivalent reward cash value percentage of a cost of an item.

8. The computing device of claim 7, wherein when the non-cash reward is in form of points, the computer-readable instructions, when executed by the one or more processors, are to convert the points into a nominal cashback based on the retrieved reward rules.

9. The computing device of claim 7, wherein when the non-cash reward is in form of mileage, the computer-readable instructions, when executed by the one or more processors, are to convert the mileage into a nominal cashback based on the retrieved reward rules.

10. The computing device of claim 1, wherein the position detector comprises at least one of a uniform resource locator (URL) reader, cell phone towers, a global positioning system (GPS) device, a geomagnetic sensor, a local positioning system (LPS), a triangulation system, a trilateration system, a multilateration system, an indoor positioning system, a hybrid positioning system, a real-time locating system, or a dynamic positioning system.

11. The computing device of claim 1, wherein the account information comprises at least one of identification number, expiration date, security number, name, address, phone number, electronic mail address, website address, income, spending habits, age of a consumer, credit limit, amount of credit that remains to reach a maximum reward cap of each of the plurality of payment applications, or time remaining until expiration of an initial offer.

12. The computing device of claim 1 wherein the computer-readable instructions to rank each of the plurality of payment applications, when executed by the one or more processors, are further to rank, based on an inputted parameter, each of the plurality of payment applications.

13. The computing device of claim 12, wherein the inputted parameter comprises a user-defined goal.

14. The computing device of claim 13, wherein the user-defined goal comprises at least one of nominal cashback, interest rate, points, or travel mileage.

15. The computing device of claim 1, wherein the secondary reward rule of the one or more of the plurality of payment applications comprises a lower percent return on each sale.

16. The computing device of claim 1, further comprising a reminder associated with parameters associated with at least one of primary reward rules or secondary reward rules for each of the plurality of payment applications.

17. The computing device of claim 16, wherein the parameters comprise at least one of limited-time interest rate, special holiday rewards, or reaching a threshold spending amount within a predetermined time to receive a reward.

18. The computing device of claim 1, wherein the ranking of the plurality of payment applications is shown to a consumer for selection and the computing device receives an indication of selection of a payment application; and base on the selection of the payment application communicate information of a selected one of the ranked plurality of payment applications to a point of sale terminal for the potential transaction.

19. A method comprising one or more non-transitory computer-readable storage media embodying computer-readable instructions which, when executed by one or more processors, are to:
retrieving reward rules associated with a plurality of accounts associated with one or more financial institutions;
retrieving financial information of a user; and
determining if the user qualifies for any of the plurality of accounts based on the retrieved user financial information;
when the user qualifies for none of the plurality of accounts, based on the retrieved user financial information, provide the user with a recommended account at the one or more financial institutions;
when the user qualifies for one of the plurality of accounts, provide the user with a platform for the user to apply for the one of the plurality of accounts; and
when the user qualifies for more than one of the plurality of accounts, determine a best match account among the plurality of accounts, based on the retrieved user financial information and best reward associated with the plurality of accounts, and provide the user with the platform for the user to apply for the best matched account.

20. A computer readable medium embodying computer-readable instructions which, when executed by one or more processors, are to:
determine at least one of a category or a sub-category associated with a merchant;
retrieve account information of a plurality of payment applications;
retrieve reward rules associated with each of the plurality of payment applications;
associate each of the retrieved reward rules to the determined at least one of the category or the sub-category associated with the merchant;
determine available rewards based on each of the retrieved reward rules,
wherein, to determine the available rewards, the one or more processors is to:
generate a report for the plurality of payment applications, wherein the generated report provides at least one of
an amount of credit that is used or is available, or
an amount of time remaining prior to invalidation of a reward rule;
based on the determined available rewards, rank each of the plurality of payment applications; and
communicate information of ranked payment applications to a point of sale terminal for the merchant.
